(19) United States
(12) Patent Application Publication
(10) Pub. No.: US 2015/0052852 A1
(43) Pub. Date: Feb. 26, 2015

(54) METHOD AND DEVICE FOR CAN MANUFACTURE AND CANNING

(71) Applicant: KRONES AG, Neutraubling (DE)

(72) Inventors: Karl-Heinz Achhammer, Woerth/Donau (DE); Michael Auburger, Bruck (DE)

(73) Assignee: KRONES AG, Neutraubling (DE)

(21) Appl. No.: 14/387,856

(22) PCT Filed: Feb. 21, 2013
(86) PCT No.: PCT/EP2013/053459

§ 371 Date: Sep. 25, 2014

(30) Foreign Application Priority Data
Apr. 17, 2012 (DE) 10 2012 206 297.1

(51) Int. Cl. B67C 7/00; B21D 51/26; B65B 55/24

(52) U.S. Cl. CPC B67C 7/0073; B65B 55/24; B21D 51/26
USPC 53/411; 53/456; 53/426; 53/563; 53/131.1; 53/167; 53/131.2

(57) ABSTRACT

A method and a device for can manufacture and canning, having cans manufactured in a manufacturing process and filled in a filling process, the manufacturing process being integral with the filling process in one plant, and the cans being transported from the manufacturing process to the filling process in a hygienic conveyor.

### CROSS-REFERENCE TO RELATED APPLICATION

The present application is the United States national phase of International Patent Application No. PCT/EP2013/053459, filed Feb. 21, 2013, which application claims to German Application No. 10 2012 206 297.1, filed Apr. 17, 2012. The priority application is hereby incorporated by reference.

### FIELD OF THE DISCLOSURE

The disclosure relates to a method and a device for can manufacture and canning

### BACKGROUND

It is known that cans are used as containers for beverages and paste-like products. In this, the cans are manufactured in a manufacturing plant for beverage cans from sheet metal, where the cans are composed of a can body and a lid. The lids are after the filling process flanged with a closure machine onto the can body.

In the manufacture of the can body, circular disk-shaped sheet metal blanks are first punched from the sheet metal. A bowl is subsequently formed from each sheet metal blank using a metal forming process and is then subsequently in a ironing process turned into the final shape of the can body. An ironing agent is used for this which must then again be washed off in the manufacturing process. Furthermore, the cans are already in the manufacturing plant coated on the interior and the exterior is provided with a paint finish and/or a print for the final product. The can is for the subsequent application of the lid (after filling) further provided with a constriction at the neck and is then stacked onto pallets for transport. Such manufacturing plants for cans are designed for significantly larger amounts, for example 2000 cans per minute, than a typical filling line can process.

DE10 2010 000 094A1 alternatively proposes a tool and a method for the manufacture of can bodies, where both the bowl as well as the final can body are manufactured in a two-step process in one tool. Can manufacture is thereby simplified and is made available also for smaller quantities of 500 cans per minute.

The palletized cans are now transported from the can manufacturing plant to a filling plant, for example, with a truck. In the filling plant, the can bodies are with a pusher first placed onto a conveyor belt and undergo inspection to detect production and transport damage. Furthermore, the can bodies are prior to the actual filling process still cleaned, because contamination can occur during transport or sterile transport would be very costly, respectively. The can bodies can now by a filling plant be filled with a product, for example, with a beverage and then closed with a closure machine. The lid made of metal is there flanged onto the can opening. To protect the product contained in the closed can from germ contamination, the closed and filled can is now supplied to a pasteurization plant and then with a packaging machine arranged onto pallets and packaged for being shipped to dealers.

The disadvantage here is that impurification or germ contamination of the cans can occur from the manufacture of the cans in a manufacturing plant and from transportation of the cans to the filling plants. The cans can also be damaged during transport. The can must therefore be inspected and cleaned immediately upstream of the filling plant. When printing, it is further not possible with the known methods to flexibly respond to urgent production needs, where e.g. containers are printed differently within a production batch.

### SUMMARY OF THE DISCLOSURE

One aspect of the present disclosure is to provide a method and a plant for can manufacture and canning that reduces the number of production steps, prevents impurification or germ contamination of the cans, and allows for greater flexibility in processing the cans.

The disclosure provides this aspect with a method for can manufacture and canning in which the manufacturing process is integral with the filling process in one plant and the cans are transported by a hygienic conveyor from the manufacturing process to the filling process.

Due to the fact that the manufacturing process is integral with the filling process in one plant, the filling process is in a direct connection with the manufacturing process. The process steps in which the cans are palletized on pallets and transported to the filling process by truck are therefore dispensed with. The cans must also no longer be placed by a pusher from the pallets onto a conveyor belt, be again cleaned and be inspected. At the same time, the possibilities of damage to the cans are greatly reduced, since they no longer need to be palletized and transported by truck between the manufacturing process and the filling process. By transporting them in a hygienic conveyor, the cans are between the manufacturing process and the filling process located within a germ-reduced region and the risk of impurification or germ contamination is reduced.

The cans can be filled with beverages, hygiene products, pastes, chemical, biological and/or pharmaceutical products. The method can be applied in particular in a beverage processing plant. The cans can be made of a metal, in particular of aluminum and/or tinplate. The cans can be internally provided with a plastic coating that protects in particular the filled product. The cans can also externally be provided with a paint finish, a print and/or a label in particular identifying the content of the can. The cans can comprise a can body and/or lid. The lid can comprise a closure which is in particular suited for removal of the can content.

The manufacturing process can comprise punching out a circular disk-shaped sheet metal blank, forming the sheet metal blank into a bowl, and/or a subsequent ironing process. The ironing process can comprise the use of an ironing agent. The manufacturing process can alternatively comprise forming a flat blank into a bowl and forming the bowl into a can body in a two-step operation in a single tool. The manufacturing process can also comprise printing onto the can. The manufacturing process can comprise forming the can body opening to a constricted neck. The manufacturing process can further comprise a cleaning step in which in particular contaminants of the cans are blown out, the cans are cleaned with a cleaning agent, disinfected and/or dried. The manufacturing process can comprise coating the interior surfaces of the can.

Hygienic can mean that the number of germs relative to the environment is reduced. Hygienic conveyor can mean that it comprises a transport device which is at least in part located within a germ-reduced zone. Germ-reduced zone can mean that the zone has a lower number of germs than the environment. The hygienic conveyor can comprise a housing which is in particular tunnel-like and protects the cans from impurification or germ contamination during transport. Purified gas having a higher pressure than the ambient air can be within the hygienic conveyor. The ambient air is thereby prevented from entering into the hygienic conveyor. The hygienic conveyor can comprise a transport device having no lubricant in the area of contact surfaces to the cans.

The filling process can comprise filling the can with a beverage, with a hygiene product, with a paste, with chemical, biological and/or pharmaceutical products. The filling process can comprise closing the can body with a lid.

Being integral can mean that the manufacturing process and the filling process occur within one plant. Being integral can also mean that the manufacturing process and the filling process are associated with a conveying device, which is in particular the hygienic conveyor. The manufacturing process can be integral with a plurality of filling processes, in particular where the cans are transported by a plurality of hygienic conveyors between the manufacturing process and the filling process. The production quantity of cans in the manufacturing process can correspond to the filling quantity of one or more filling processes. A buffer storage for intermediate storage of cans can be disposed between the manufacturing process and at least one filling process. The buffer storage can in particular comprise a germ-reduced zone in which the cans are stored.

In the method for can manufacture and canning, cans can be cleaned and/or disinfected by the hygienic conveyor and transferred in particular to a hygienic region of a filling plant. Due to the fact that the cans are cleaned and/or disinfected in the hygienic conveyor, this step can be omitted in the manufacturing process and there be performed during transport of the cans from the manufacturing process to the filling process. The cans can be cleaned in the hygienic conveyor using at least one cleaning and/or disinfecting agent which is in particular liquid and/or vaporous. For removing metal particles or swarf, the can be blown clean with compressed air, in particular prior to cleaning and/or disinfecting.

The method can have the manufacturing process and the filling process be synchronized with each other. The cans then do not need to be temporarily stored in a buffer. Synchronized can mean that the manufacturing process produces the same number of cans as the filling process can fill. Synchronized can also mean that the drive units of the manufacturing process and the filling process are synchronized. The output of the hygienic conveyor can also be synchronized with the manufacturing process and/or of the filling process. Synchronization can be performed with one work cycle signal of the manufacturing process, of the hygienic conveyor and/or of the filling process, this signal can in particular be transmitted via a data interface.

In this method, the cans can be dried in the hygienic conveyor. Residues of the cleaning agent and/or of the disinfectant are thereby removed from the cans and no remnants thereof can enter the filled product.

In the method, moreover, the cans pass through a lock, protecting the filling process against contaminants, cleaning and/or disinfecting agents, which is in particular an air curtain. The lock can be disposed in particular between a wet and a dry transport section. On the one hand, cans can be conveyed through the lock and, on the other hand, contaminants, cleaning and/or disinfecting agents can be prevented from entering into the region of the filling process and to there contaminate the filled product. The filling process can comprise a hygienic region where contaminants and/or germs are reduced. The hygienic region can there be filled with purified gas, in particular with purified air. The hygienic region can exhibit higher gas pressure than the hygienic conveyor. No particles are therefore pressed from the cleaning region through the air curtain into the hygienic region of the filling process. The filling process can be a so-called ultra clean or aseptic filling process. Aseptic or ultra clean can mean that the number of germs within the filling process is reduced relative to the environment by protective measures and/or by regular cleaning processes of the filling process.

The cans can in the hygienic conveyor be transported by a conveying device, in particular via a wire gutter. Due to the cans being transported with a wire gutter, the contact surface of the conveying device with the can is reduced to a minimum and the risk of contamination of the can by germs at the conveying device is thereby reduced.

The cans can after the filling process in the method be applied a print and/or label. This allows for more flexible use of the plant because the cans can be applied a print and/or a label irrespective of the respective filled product in accordance with the current needs. For example, a rapid product change within the canning plant can be performed and printing or labeling of the cans can be adapted accordingly. Printing can be performed by pad printing, flexo printing, offset printing and/or a direct printing method.

With the method, the cans can in the manufacturing process be produced from metal, in particular from aluminum alloy and/or from tinplate.

A further aspect of the disclosure provides a plant for can manufacture and canning which is characterized in that the plant comprises a manufacturing device and a filling device for cans, where the manufacturing device is integral with the filling device and the plant comprises a hygienic conveyor between the manufacturing device and the filling device.

Due to the plant comprising a manufacturing device being integral with a filling device for cans, it is possible to both manufacture and fill the cans in one beverage processing plant. This eliminates transporting the cans from a manufacturing device to a filling device. This additionally reduces the risk of the cans being damaged during transport from the manufacturing device to the filling device. In addition, the cans do not need to again be cleaned and inspected prior to being supplied to the filling device.

Contamination of the cans with contaminants and/or germs is reduced by the hygienic conveyor between the manufacturing device and the filling device.

Being integral can mean that the manufacturing device and the filling device are connected to each other via a conveying device, which is in particular the hygienic conveyor. The plant can of course comprise several filling devices and/or several hygienic conveyors. A manufacturing device can in particular be integral with several filling devices.

The cans can comprise a can body and/or lid. The manufacturing device can be configured to manufacture can bodies and/or lids. The cans, the can body and/or the lid can be made of metal, in particular, of aluminum or tinplate.

The hygienic conveyor can be configured to transport cans, can bodies and/or lids. The hygienic conveyor can comprise a housing which is filled with purified gas, in particular with purified air, in particular where the housing is shaped as a tunnel. The purified gas can there exhibit higher pressure than the ambient air. The hygienic conveyor can comprise a conveying device which is designed as being germ-repellent.

The hygienic conveyor can comprise a cleaning device for cleaning, disinfecting and/or drying the cans. The cans can during transport from the manufacturing device to the filling device be cleaned of contaminants and/or germs. Due to the cleaning device being disposed in close proximity to the filling device, recontamination of the cans prior to filling can be avoided. The cleaning device can there be designed with nozzles spraying cleaning agents and/or disinfectants into the cans. The cleaning device in the hygienic conveyor can comprise a collection device for the cleaning agent.

The hygienic conveyor can comprise a lock, in particular an air curtain for separating a wet and a dry transport section of the hygienic conveyor. The hygienic conveyor can comprise several transport sections that can be wet or dry. The cleaning device can be associated with a wet transport section. A dry transport section can be associated with a hygienic region of the filling device. Due to the lock, the cans can be transported through, but it is prevented by the lock that contaminants or germs enter the transport section disposed downstream. The air curtain can in particular be designed such that an air flow runs transversely across the direction of transport. In particular the dry transport section of the hygienic conveyor can exhibit higher pressure than the wet transport section.

The filling device can comprise a hygienic region, which is germ-reduced. The hygiene region can be filled with purified gas, which in particular exhibits higher pressure than the ambient air or the gas in the hygienic conveyor. The purified gas can in particular be purified air. The purified gas can in particular in the hygiene region of the filling device exhibit higher air pressure than the wet transport section of the hygienic conveyor.

The hygienic conveyor can comprise at least one conveying device, in particular a wire gutter and/or a conveyor belt. Due to the design of the conveying device as a wire gutter, the contact surfaces between the conveying device and the cans can are be minimized thereby reducing the risk of contaminants or germs being transferred from the conveying device to the cans.

The sheet metal for manufacturing the cans can be coated with a plastic layer as an ironing agent, where the plastic layer is in particular made of polyethylene terephthalate (PET). Due to the sheet metal for manufacturing the cans already being coated with a plastic layer as an ironing agent, a liquid ironing agent for manufacturing the cans is no longer required. The cans therefore do not need to be cleaned of the ironing agent after manufacture. The plastic layer can in particular be of food grade plastic. The sheet metal can there either be coated with the plastic layer both on one as well as on both sides.

The filling device can be associated with a closure machine. The cans are thereby closed with a lid immediately after being filled. The closure machine can be adapted to flange the opening of a can body to a lid. The lid can there comprise a closure that is adapted to remove the filled product from the can.

The filling device can be associated with a labeling and/or a printing device. This allows for flexible printing or labeling onto the can after being filled. The filling device can also quickly be converted to another product. The printing device can be configured as a pad printer, flexo printer, offset printer, and/or as a direct printer.

### BRIEF DESCRIPTION OF THE DRAWINGS

Further features and advantages of the disclosure shall be explained below with reference to the figures by way of example.

FIG. 1 shows a flow chart of a method for can manufacture and canning according to prior art.

FIG. 2 shows a flow chart of a method according to the disclosure for can manufacture and canning; and

FIG. 3 shows a diagram of a plant according to the disclosure for can manufacture and canning in a schematic lateral view.

### DETAILED DESCRIPTION

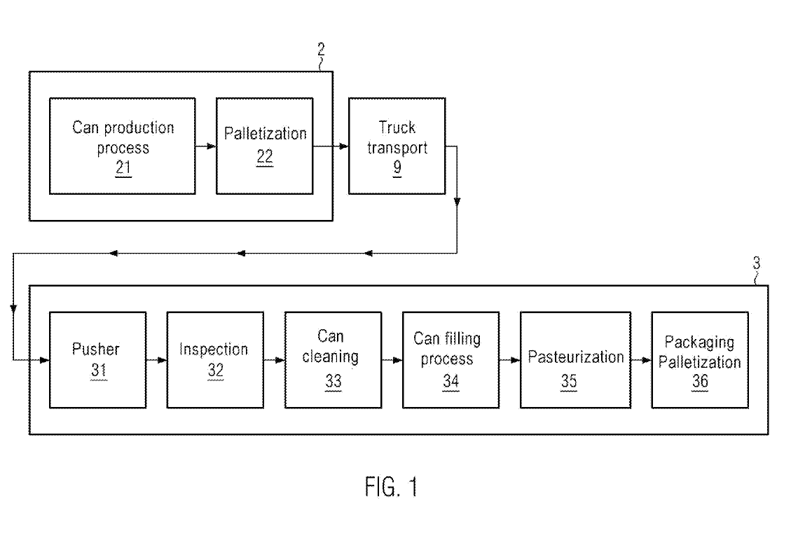

FIG. 1 shows a flow chart of a method for can manufacture and canning according to prior art. In this, a manufacturing process for cans 21 is arranged in a can manufacturing factory 2 with which cans can be manufactured from a can body and a lid. Circular disk-shaped sheet metal blanks are first in a first manufacturing step punched from sheet metal. They are then in a forming press transformed to a bowl shape. The bowls are then applied an ironing agent and in a further metal forming machine stretched to the desired can shape in a so-called ironing process. The opening of the can is then trimmed and the can is cleaned. Residues from can manufacturing are in the cleaning process removed so that the cans can then be coated on the interior with a protective layer and be printed on the outside The print is there applied according to the requirements of the beverage canner. In a further step, the neck of the can is slightly constricted. As a final step in the manufacturing process for cans 21, the completed cans are cleaned and subjected to inspection to sort out damaged cans.

The cans are during palletizing 22 now removed from the conveyor belt of the manufacturing process and stacked on a pallet. The cans are additionally protected with cardboard and wrapped with film. The cans thus packaged are there provided for further transport.

The cans are now by trucking 9 transported from the can manufacturer to a beverage canner.

The cans on the pallets are in the beverage filling plant 3 first placed by a pusher 31 onto a conveyor belt. The cans are there arranged such that they can continue to run on the conveyor belt sequentially one after the other. The cans then pass through inspection 32 in which damage to the cans, in particular from transportation, is detected. Defective cans are then sorted out immediately. A cleaning agent and/or disinfectant is in the subsequent can cleaning process 33 sprayed onto the cans whereby contaminants and germs are reduced. The cans are during the can cleaning process 33 additionally dried to remove remnants of the cleaning agent or the disinfectant from the cans. The cans can now be supplied to the filling process 34 in which the respective product is filled into the cans, which presently for example is a beverage. The can bodies are now by a closure machine in the filling process 34 closed with a lid that comprises a closure for later removal of the beverage. The lid is there flanged to the can.

Since the filling plant and the cans are not sterile, remaining germs in the beverage are killed by pasteurization 35. The cans are heated such that the germs die.

The cans are then further conveyed for packaging and palletizing 36 wherein the filled and closed cans are stacked on pallets such that they can be transported to the dealers.

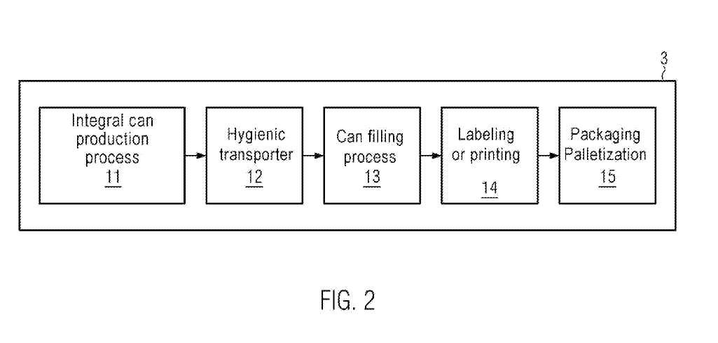

FIG. 2 shows a flow chart of a method according to the present disclosure for can manufacture and canning It can there be seen that the manufacturing process 11 for the cans is integral with the filling process 13 in the beverage production plant 1. For example, both processes are located within one building. Long transport distances between the manufacturing process 11 and the filling process 13 can therefore be avoided. A hygienic conveyor 12 is also disposed between the manufacturing process 11 and the filling process 13 with which contaminants or germs in the cans can be reduced. Cleaning steps can there be reduced and at the same time sensitive products can also be filled into the cans due to the reduced risk of the cans being contaminated.

In the manufacturing process for cans 11, both the can bodies as well as the lids are produced to form cans. In the manufacturing process for 11 cans, circular disk-shaped sheet metal blanks are first punched from sheet metal. They are then supplied to a manufacturing device for cans. In this, the sheet metal blanks are in a two-step operation in one tool first formed to a bowl and then to a can body. The sheet metal blanks are there coated with a plastic layer as an ironing agent and no liquid ironing agent is therefore necessary. The cans are also coated from the interior with a protective layer so that the filled product can not directly contact the metal.

Following the manufacturing process 11, the cans are transferred to the hygienic conveyor 12. The cans are therein first blown clean with compressed air to remove swarf from the manufacturing process. Liquid cleaning agent is then sprayed onto the cans to remove residual contaminants and to kill germs. The liquid cleaning agent is sprayed by nozzles onto the can on the interior and/or the exterior. In order to now remove residues of the cleaning agent, the can is dried in a dryer. The entire cleaning process occurs in the hygienic conveyor in a wet transport section, while the cans are continuously conveyed with a wire gutter. The contact surface between the cans and the conveying device is there minimized.

The cans are then passed through an air curtain to a dry transport section. Clean air is present in the dry transport section so that the cans are recontaminated as little as possible in the further course. The pressure of the purified air in the dry transfer section is higher than the pressure of the air in the wet transport section so that no contaminants or cleaning agent can pass from the wet transport region to the dry transport region. Within the dry transport region, the cans are likewise further transported with a wire gutter.

The cans are subsequently transferred by the hygienic conveyor 12 into a hygienic region of the filling process 13. This hygienic region of the filling process 13 is also germ-reduced. The cans are now with the filling process 13 filled with a beverage. This beverage is particularly sensitive to germ contamination. For example, the cans are guided in a carousel and filled. The cans are then within the filling process 13 closed by a closure machine with a lid. The lid is flanged onto the can body.

After the filling process 13, the cans are passed on to a labeling or printing process 14. In this case, the cans are applied a print according to the canned beverage. This occurs, for example, by use of a direct printing system.

After printing 14, the closed and filled cans are passed on to palletizing 15. The cans are there stacked and packed on pallets and can like this be delivered to customers.

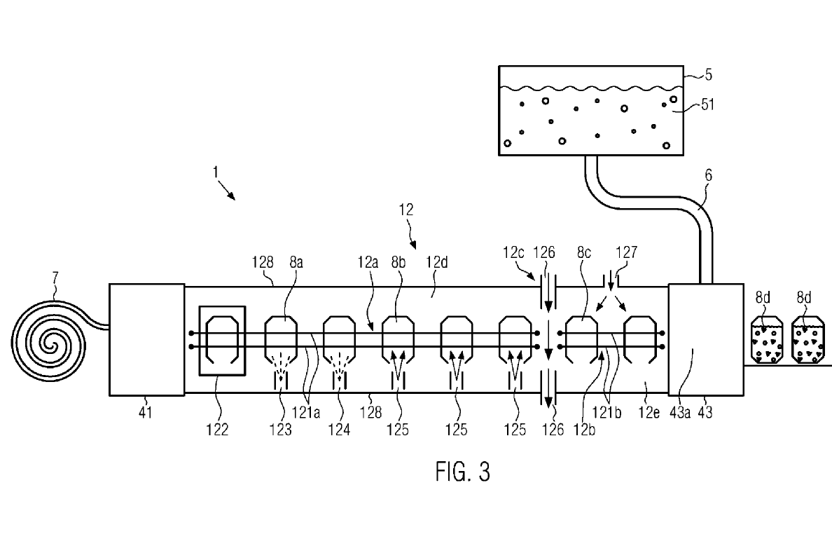

FIG. 3 shows a representation of a plant 1 according to the disclosure for can manufacture and canning in a schematic lateral view. It can there be seen that the sheet metal 7 is in a manufacturing device 41 processed to form cans 8 which are then transported in the hygienic conveyor 12 to the filling device 43. The cans 8 are there filled with a beverage 51 and closed.

For this, aluminum sheet 7 is first unwound from a roll and received by the manufacturing device 41. Circular disk-shaped sheet metal blanks are punched out of the aluminum sheet 7. In this, the sheet metal blanks are in a two-step operation in one tool now formed to a can body. The tool combines forming the sheet metal blank into a bowl and forming the bowl to a can body. The sheet metal blanks are there coated with a plastic layer made of PET so that no further ironing agent needs to be used Parallel to that, the lids are in the manufacturing device 41 formed from sheet metal (presently not shown). The cans 8 are therefore composed of a can body and a lid. The cans 8 are now in the interior coated with a protective layer that is of a food grade. This protective layer prevents the product filled in later from directly contacting the aluminum/tinplate. In this, the protective layer can be applied either conventionally by coating or can already be present due to the PET on the sheet metal.

The cans are now transferred from the manufacturing device 41 to the hygienic conveyor 12. The cans are there transported by the conveying devices 12a and 12b within a housing 128 protecting the conveying stretch from contamination from the environment. The conveying devices 12a and 12b are there formed as wire gutters 121 a and 121b so that the cans 8 contact the conveying devices 12a and 12b as little as possible. The cans 8 are transported on in the hygienic conveyor continuously from the manufacturing device 41 to the filling device 43.

The cans 8 can first during the further transport to the filling device 43 be heated with the homogenizing device 122. The PET inner layer can therewith be homogenized (e.g., for correction of material distribution after drawing the PET-coated round blanks/sheet metal blanks in the manufacturing device 41).

During a subsequent cleaning process, the contaminated cans 8a are first blown clean from the inside with a nozzle 123 to remove swarf from the manufacturing process. Then a cleaning device 124 sprays a cleaning agent onto the cans 8a which acts both to remove contaminants and to disinfect. The cleaned cans 8b are subsequently dried by the drying device 125 so that residues of the cleaning agent are removed. It is to be understood that the cans 8a and 8b are cleaned and dried both on the inside as well as on the outside. It is likewise to be understood that both the can body as well as the lid are there cleaned, dried and transported. The cans there move within a wet transport section 12d.

The cans are now from the wet transport section 12d passed through the lock 12c being formed as an air curtain 126 to the dry transport section 12e. Purified air is there supplied to the dry transport section 12e by an air supply 127 so that higher air pressure is there obtained than in the wet transport section 12d. The cleaning agents, contaminants, and germs are thereby prevented from passing from the wet transport section 12d to the dry transport section 12e and the cans can at the same be further transported through the lock 12c.

By having the hygienic conveyor 12 be designed in this manner, it is now possible to transfer the cleaned cans 8c from the dry transport section 12e to a hygienic region 43a of the filling device 43. Impurification or germ contamination of the cans 8c can with this arrangement be greatly reduced. Therefore particularly sensitive products can be filled into the cans 8c.

The cans 8c are in the filling device 43 now be filled with a beverage 51 from a tank 5 which is via a pipe 6 connected to the filling device 43. The can bodies are subsequently closed by a closure machine with a lid, where the lid is flanged onto the can body. The completely filled cans 8d are downstream of the filling device 43 passed on for further processing. In this, the cans 8d are applied a print and packaged stacked on pallets (presently not shown). It is also possible that the cans 8d are applied a label or print downstream of the filling device 43.

Since the entire manufacturing process and the filling process occur within one beverage manufacturing plant 1, the cans 8 are contaminated and contacted by germs so little that pasteurization 35 can presently be dispensed with even with sensitive product. The expenses for trucking 9 the cans 8 from a manufacturing plant 2 to a filling plant 3 can additionally be eliminated; the expenses for palletizing 22, the pusher 31 and inspections 32 can also be dispensed with (see FIG. 1). In addition, the cans 8 can be applied a print in a flexible manner because printing occurs only after the filling process.

It is understood that the features previously mentioned in the embodiments described are not restricted to these specific combinations and are also possible in any other combinations.

1. A method for can manufacture and canning, comprising manufacturing cans in a manufacturing process and filling the cans in a filling process, the manufacturing process being integral with the filling process in one plant, and
the cans from the manufacturing process being transported to the filling process in a hygienic conveyor.

2. The method for can manufacture and canning according to claim 1, where said cans are cleaned and/or disinfected by said hygienic conveyor and transferred in particular to a hygienic region of a filling plant.

3. The method for can manufacture and canning according to claim 1, and the manufacturing process and the filling process being synchronized to each other.

4. The method for can manufacture and canning according to claim 1, and the cans are dried in the hygienic conveyor.

5. The method for can manufacture and canning according to claim 1, and the cans pass through a lock for the protection of the filling process from contaminants, cleaning and/or disinfecting agents.

6. The method for can manufacture and canning according to claim 1, and the cans in the hygienic conveyor are transported by a conveying device.

7. The method for can manufacture and canning according to claim 1, and the cans after said filling process have applied a print and/or a label.

8. The method for can manufacture and canning according to claim 1, and the cans in the manufacturing process are manufactured from metal.

9. A plant for can manufacture and canning, comprising:
a manufacturing device and a filling device for cans, the manufacturing device being integral with said filling device, and
a hygienic conveyor between the manufacturing device and the filling device.

10. The plant for can manufacture and canning according to claim 9, and the hygienic conveyor comprises a cleaning device for cleaning, disinfecting and/or drying the cans.

11. The plant for can manufacture and canning according to claim 9, and the hygienic conveyor comprises a lock.

12. The plant for can manufacture and canning according to claim 9, and the hygienic conveyor comprises at least one conveying device.

13. The plant for can manufacture and canning according to claim 9, and sheet metal for the manufacture of the cans is coated with a plastic layer as an ironing agent.

14. The plant for can manufacture and canning according to claim 9, and the filling device is associated with a closure machine.

15. The plant for can manufacture and canning according to claim 9, and the filling device is associated with a labeling device and/or a printing device.

16. The method for can manufacture and canning according to claim 5, and the locks comprises an air curtain.

17. The method for can manufacture and canning according to claim 6, and the conveying device is a wire gutter.

18. The method for can manufacture and canning according to claim 8, and the metal comprises one of an aluminum alloy, a tinplate, or a combination thereof.

19. The plant for can manufacture and canning according to claim 11, and the lock comprises an air curtain for separating a wet and a dry transport section of the hygienic conveyor.

20. The plant for can manufacture and canning according to claim 12, and the at least one conveying device comprises one of a wire gutter, a conveyor belt, and a combination thereof.

21. The plant for can manufacture and canning according to claim 13, and the plastic layer comprises polyethylene terephthalate (PET).
